(19) United States
(12) Patent Application Publication
(10) Pub. No.: US 2025/0355447 A1
(43) Pub. Date: Nov. 20, 2025

(54) METHOD FOR ORDER PICKING USING AN AUTOMATED GUIDED VEHICLE WITH A ROTATABLE GOODS RECEIVING DEVICE

(71) Applicant: Safelog GmbH, Markt Schwaben (DE)

(72) Inventors: Christian WOLTER, Schliersee (DE); Michael WOLTER, Schliersee (DE)

(21) Appl. No.: 19/203,572

(22) Filed: May 9, 2025

(30) Foreign Application Priority Data
May 15, 2024 (DE) 102024113630.8

(51) Int. Cl. G05D 1/667; G05D 1/69; G05D 105/20; G05D 107/70; G05D 109/10

(52) U.S. Cl. CPC G05D 1/667; G05D 1/69; G05D 2105/20; G05D 2107/70; G05D 2109/10

(57) ABSTRACT

A method is for picking goods assigned to different orders using a picking system with an automated guided vehicle and a goods receiving device rotatably mounted thereon for receiving goods in order-specific goods sectors. The method includes providing the first good to be picked, assigned to a first order, at a first transfer position, picking up the first good at the first transfer position by an order picker, positioning the picking system near the order picker, and rotating the goods receiving device relative to the automated guided vehicle in such a way that a first goods sector of the goods receiving device assigned to the first order faces the order picker.

### CROSS REFERENCE TO RELATED APPLICATIONS

This application claims priority to German Application No. 10 2024 113 630.8, filed May 15, 2024, the contents of each of which are incorporated by reference herein.

### FIELD OF THE INVENTION

The present invention relates to a method and a system for picking goods by means of an automated guided vehicle.

### BACKGROUND

An automated guided vehicle is a ground-level, floor-bound vehicle with its own drive that is automatically controlled and guided in order to transport goods horizontally. Automated guided vehicles are also referred to as A GVs.

(Order) picking is understood to mean the compilation of order-specific subsets of goods from a total quantity of goods provided.

The use of automated guided vehicles for picking goods is known from the state of the art. The document WO 2018 064 639 A 1, which describes a system for picking goods in which a human order picker (a person who picks goods) is supported by an automated guided vehicle, is an example from the pool of previously known publications. The order picker is located in an order picking area which is delimited by several shelves in which the goods to be picked are located.

Document AT 17770 U 1 describes a storage and picking system as well as picking processes for improved goods transfer between two storage areas. Document WO 2017 214652 A 1 describes an order picking system with a transport robot for driving under individual shelves and transport trolleys. The document EP 2 102 080 A 1 describes an autonomous transport vehicle that is used in a method for picking goods.

An automated guided vehicle (AGV) transports an AGV trolley with shelf-like storage options for cartons and positions it near the order picker. The order picker removes the goods to be picked from the shelves in the picking area and places them in the cartons on the AGV trolley, sorted by order. Once the AGV trolley has been fully picked or loaded by the order picker, it is transported by the automated guided vehicle (AGV) to another area for further processing.

### SUMMARY

The present disclosure is based on the task of providing a method and an associated system for picking goods by means of an automated guided vehicle, which is characterized by improved practicability, in particular with regard to the error rate and the time required for the picking process and the distances to be covered by the order picker.

This task may be solved by a method for picking goods assigned to different orders using a picking system, a picking system, and a computer program in accordance with this disclosure.

A method for picking goods assigned to different orders using a first picking system comprises a first automated guided vehicle and a first goods receiving device rotatably supported on the first automated guided vehicle for receiving goods in order-specific goods sectors assigned to the different orders, wherein a first good is assigned to a first order and a second good is assigned to a second order, comprising the following steps:
A 1) providing the first good to be picked, assigned to the first order, at a first transfer position,
B 1) picking up the first good to be picked at the first transfer position by an order picker,
C 1) positioning the first automated guided vehicle together with the first picking system in the vicinity of the order picker,
D 1) rotating the first goods receiving device relative to the first automated guided vehicle in such a way that a first goods sector of the first goods receiving device assigned to the first order faces the order picker,
E 1 placing the first good to be picked in the first goods sector of the first goods receiving device by the order picker,
A 2) providing the second good to be picked, assigned to the second order, at a second transfer position,
B 2) picking up the second good to be picked at the second transfer position by the order picker,
C 2) positioning the first automated guided vehicle together with the first order picking system in the vicinity of the order picker,
D 2) rotating the first goods receiving device relative to the first automated guided vehicle in such a way that a second goods sector of the first goods receiving device assigned to the second order faces the order picker, and
E 2 placing the second good (5.2) to be picked in the second goods sector (7.2) of the first goods receiving device (3.1) by the order picker (10).

The method is based on the use of an (order) picking system which comprises an automated guided vehicle and a goods receiving device rotatably mounted on the automated guided vehicle with order-specific goods sectors for receiving goods.

The method is based on the realization that by rotating the goods receiving device so that the goods sector relevant to the current order faces the order picker, the walking distances of the order picker and thus the time required for order picking can be considerably reduced.

In addition, the error rate during order picking (i.e. the proportion of goods that are not assigned to the correct order) can also be reduced, as the order-specific rotation of the goods pick-up device can reduce the risk of the order picker “grabbing the wrong good”.

The first and second goods can also be provided at one and the same transfer position. In this case, the first and second transfer positions coincide.

Furthermore, the first and second orders can be one and the same order or different orders. In the former case (first and second order are identical), the first and second goods are stored in a common goods sector assigned to this order in the first picking system. If, on the other hand, the orders are different, the first and second goods are stored in different goods sectors of the first picking system.

The order picker can be a human or a robot.

According to a preferred embodiment of the invention, the goods to be picked are provided at a transfer position according to step A 1 and optionally step A 2 by using a second picking system, wherein the second picking system comprises a second automated guided vehicle and a second goods receiving device rotatably mounted on the second automated guided vehicle for providing goods in a plurality of goods sectors, with the following steps:
A 11) providing the first good to be picked in a first goods sector of the second goods receiving device and defining this first goods sector as the first transfer position,
A 12) positioning the second automated guided vehicle in the vicinity of the order picker,
A 13) rotating the second goods receiving device relative to the second automated guided vehicle in such a way that the first goods sector of the second goods receiving device faces the order picker,

and optionally afterwards
A 21) providing the second good to be picked in a second goods sector of the second goods receiving device and defining this second goods sector as the second transfer position,
A 22) positioning the second automated guided vehicle in the vicinity of the order picker,
A 23) rotating the second goods receiving device relative to the second automated guided vehicle in such a way that the second goods sector of the second goods receiving device faces the order picker.

This preferred embodiment is based on the realization that the efficiency of the order picking process can be improved even further if a further, second order picking system (with a second automated guided vehicle and a second goods receiving device with goods sectors for providing goods, which is rotatably mounted on the second automated guided vehicle) is used to provide the goods to be picked by the order picker at the transfer positions

The second goods receiving device of the second order picking system is rotated so that the goods sector facing the order picker is the one in which the next good to be picked by the order picker is located. In this way, the walking distances of the order picker and thus the time required for order picking can be further reduced.

It is also conceivable that the first and second goods are not both provided together in the second picking system, but in different picking systems.

Furthermore, in an advantageous way according to step C 1 and/or C 2, the first automated guided vehicle is positioned in the vicinity of the order picker by the first automated guided vehicle following the order picker at a predeterminable first distance or by the first automated guided vehicle being positioned in a first order picking area, and/or according to step A 12 and/or A 22, the second automated guided vehicle is positioned in the vicinity of the order picker by the second automated guided vehicle following the order picker at a predeterminable second distance or by the second automated guided vehicle being positioned in a second order picking area.

The invention may be further manifested in an (order) picking system. The picking system comprises an automated guided vehicle and a goods receiving device rotatably mounted on the automated guided vehicle for receiving and/or providing goods in a plurality of goods sectors, adapted for use in the method.

In an advantageous manner, the automated guided vehicle comprises a turntable that can be rotated (relative to the automated guided vehicle) and on which the goods receiving device is arranged.

In particular, if the goods to be picked are clothing, it is also advantageous if the goods receiving device comprises a circumferential hanging device, in particular in the form of a clothes rail and enables clothes hangers to be hung up.

It is particularly advantageous if the circumferential hanging device is circular, elliptical or polygonal

This makes it easy to realize multi-sided accessibility of the goods receiving device.

Adjacent good sectors can be separated from each other, in particular by a flange or a pin protruding upwards from the hanging device or the clothes rail, in order to prevent goods from one good sector from slipping into the neighbouring good sector. The flange or the pin can be detachably attached, in particular to specially provided catches on the hanging device. In this way, the number and size of the good sectors can be variably adjusted.

Alternatively, it can be advantageous for other types of goods if the goods receiving device comprises a storage shelf that is accessible from several sides.

The efficiency of order picking can be increased even further if the goods sectors of the goods receiving device can each be marked by a light signal (marking) using a put-by-light device and/or a pick-by-light device.

Unintentional movement of goods from one goods sector to a neighbouring goods sector can be prevented or at least made more difficult if the goods sectors of the goods receiving device are separated from each other by goods separators.

A good separator can be realized in particular by a structural measure, such as a partition.

According to a further preferred embodiment of the invention, the automated guided vehicle is designed as an autonomous automated guided vehicle.

The invention further manifests itself in a computer program comprising instructions that cause the automated guided vehicle of an order picking to execute
the process steps C 1 and D 1 and C 2 and D 2, and/or
the process steps A 12 and A 13 and optionally the process steps A 22 and A 23.

For this purpose, the automated guided vehicle comprises a computer with a processor unit and a memory unit. In particular, the computer can be designed as a single-board computer, embedded system, digital end device, desktop computer, edge device or server. The processor unit is suitable for performing arithmetic operations and can be designed as a CPU, GPU or of the like with one or more processor cores. Furthermore, the processor unit can position the automated guided vehicle by controlling suitable actuators of the automated guided vehicle and rotate the goods receiving device relative to the automated guided vehicle. The memory unit is suitable for storing and outputting data (to the processor unit) and can be designed as a volatile or non-volatile memory.

### BRIEF DESCRIPTION OF THE DRAWING

In the following, embodiments of the invention are explained in more detail with reference to the drawing. It shows:

FIGS. 1A and 1B show a schematic representation of an order picking system according to the invention in a side view (FIG. 1A) and in a top view (FIG. 1B),

FIG. 2 shows a schematic representation of two order picking systems according to the invention,

FIGS. 3A-3D show the two picking systems according to FIG. 2 at different times during the execution of the method according to the invention,

FIGS. 4A-4D show several picking systems at different times during the execution of the method according to the invention,

FIGS. 5A-5B show several picking systems at different times during the execution of the method according to the invention, and

FIGS. 6 and 7 show process flow diagrams for methods according for picking goods according to the invention.

### DETAILED DESCRIPTION OF THE PREFERRED EMBODIMENTS

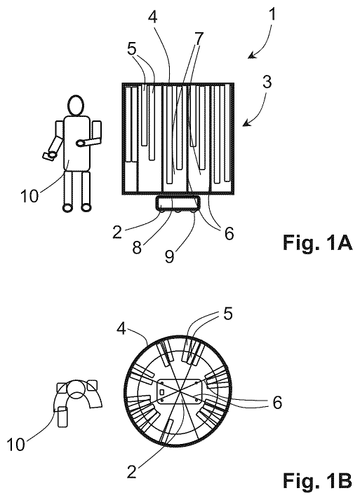

FIGS. 1A and 1B each show a schematic representation of an (order) picking system 1 according to the invention in a side view (FIG. 1A) and in a top view (FIG. 1B).

The picking system 1 comprises an automated guided vehicle 2 and a goods receiving device 3 rotatably mounted on the automated guided vehicle 2. The goods receiving device 3 comprises a circular clothes rail 4 on which goods of clothing (goods 5) suspended on hangers can be hung.

The clothes rail 4 (and therefore also the goods receiving device 3) is divided into several goods sectors 7 by partitions 6, which act as goods separators. The cloths (goods 5) hung on hangers can be stored and provided in the goods sectors 7. The goods receiving device 3 is accessible from all sides and therefore accessible from several sides.

The goods receiving device 3 is arranged on a turntable 8 of the automated guided vehicle 2, which can be rotated relative to the rest of the automated guided vehicle 2 by an actuator (not shown). The automated guided vehicle 2 also has wheels 9 driven by actuators, by means of which it can be moved and positioned.

Next to the picking system 1 is a human order picker 10, who can place the cloths (goods 5) hung on hangers in the goods sectors 7 and remove the goods 5 provided there.

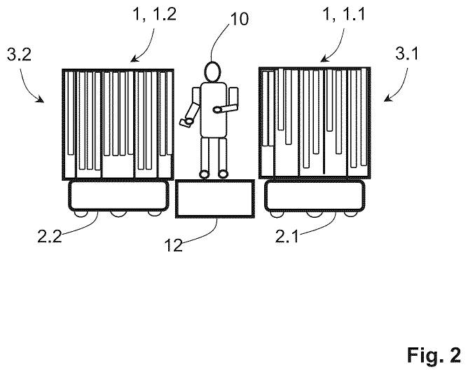

FIG. 2 schematically shows two further picking systems 1 according to the invention. Similar components are designated with the same reference signs as in FIG. 1. In order to avoid repetition, only the essential differences to FIG. 1 are discussed below.

In the first picking system 1.1, the order picker 10 places the goods 5 assigned to the various orders in the order-specific goods sectors 7.

In the second picking system 1.2, the goods 5 to be picked are provided in the goods sectors 7 at transfer positions 11.

The human order picker 10 stands on a raised platform 12 to make it easier for him to access the goods 5 in the goods receiving devices 3.

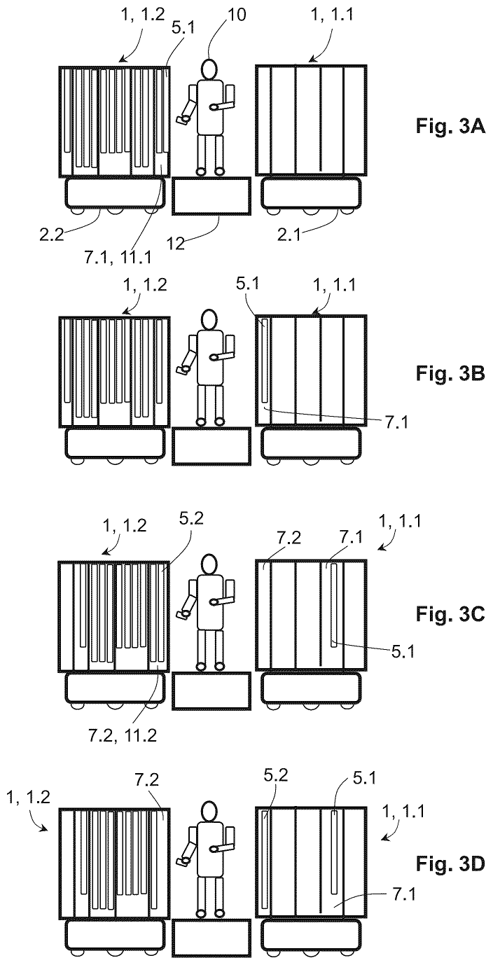

One embodiment of the method for picking goods 100 according to the invention will be explained in more detail below with particular reference to FIGS. 3A to 3D and FIGS. 6 and 7.

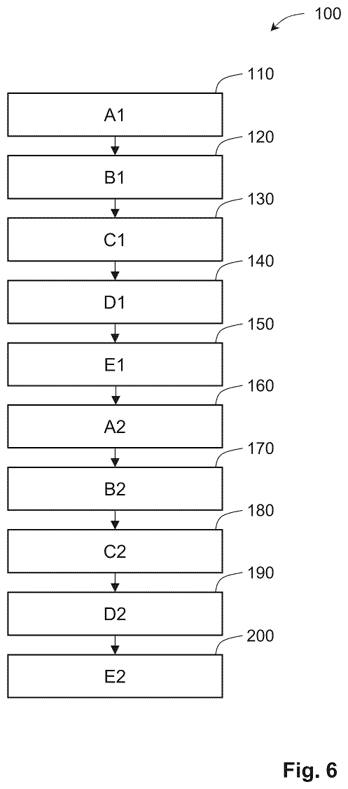

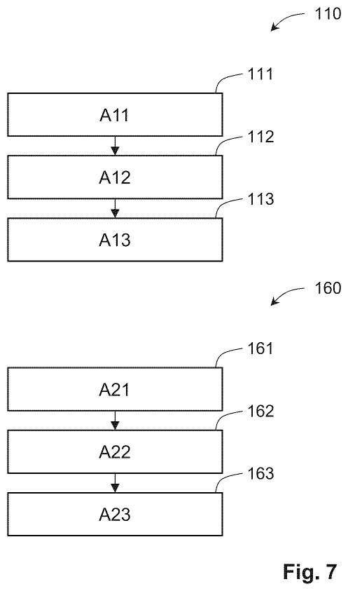

FIGS. 3A to 3D show the two picking systems 1 according to FIG. 2 at different times during the execution of the method according to the invention, FIGS. 6 and 7 show process flow diagrams of the method 100 for picking goods according to the invention.

First, according to step A 1 (110), a first good 5.1, which is assigned to a first order, is provided at a first transfer position 11.1 by the second picking system 1.2. The first good is located in a first goods sector 7.1 of the second picking system 1.2 in accordance with method step A 1 (111). This first goods sector 7.1 is defined as the first transfer position 11.1.

The second picking system 1.2 is already positioned in the vicinity of the order picker 10 in accordance with step A 12 (112). Furthermore, according to step A 13 (113), the second goods receiving device 3.2 is turned (rotated) relative to the second automated guided vehicle 2.2 in such a way that the first goods sector 7.1 (in which the first good 5.1 is located) faces the order picker 10. This situation is shown in FIG. 3A.

The order picker 10 then removes the first good 5.1 from the second order picking system 1.2 at the first transfer position 11. in accordance with step B 1 (120).

At this point, the first order picking system 1.1 is already positioned in the vicinity of the order picker 10 in accordance with step C 1 (130).

Then, according to step D 1 (140), the first goods receiving device 3.1 of the first automated guided vehicle 2.1 is rotated relative to the first automated guided vehicle 2.1 in such a way that a first goods sector 7.1 of the first goods receiving device 3.1 assigned to the first order faces the order picker 10.

The order picker 10 then places (deposits) the first good 5.1 in the first good sector 7.1 of the first good receiving device 3.1 in accordance with step E 1 (150). FIG. 3B shows the first good 5.1 deposited in the first goods sector 7.1 of the first goods receiving device 3.1.

In the next step A 2 (160), a second good 5.2 assigned to a second order is now provided at a second transfer position 11.2 by the second picking system 1.2. The first and second orders are two different orders.

The second good 5.2 is located in a second good sector 7.2 of the second good receiving device 3.2. This second good sector 7.2 is defined as the second transfer position 11.2 according to step A 21 (161).

The second automated guided vehicle 2.2 does not change its position and is already positioned in vicinity of the order picker 10 in accordance with step A 22 (162).

According to step A 23 (163), the second goods receiving device 3.2 is rotated relative to the second automated guided vehicle 2.2 so that the second goods sector 7.2 of the second goods receiving device 3.2 (in which the second good 5.2 is located) faces the order picker 10. This situation is shown in FIG. 3C.

The order picker now picks up (removes) the second good 5.2 from the second transfer sector 7.2 (second transfer position 11.2) from the second goods receiving device 3.2 in accordance with step B 2 (170).

In the meantime, the first goods receiving device 3.1 of the first automated guided vehicle 2.1 was positioned in the vicinity of the order picker 10 according to step C 2 (180) and rotated according to step D 2 (190) such that a second goods sector 7.2 of the first goods receiving device 3.1 assigned to the second order faces the order picker 10 (cf. FIG. 3C).

The order picker 10 then places the second good 5.2, which is assigned to the second order, in the second goods sector 7.2 of the first goods receiving device 3.2 in accordance with step E 2 (200).

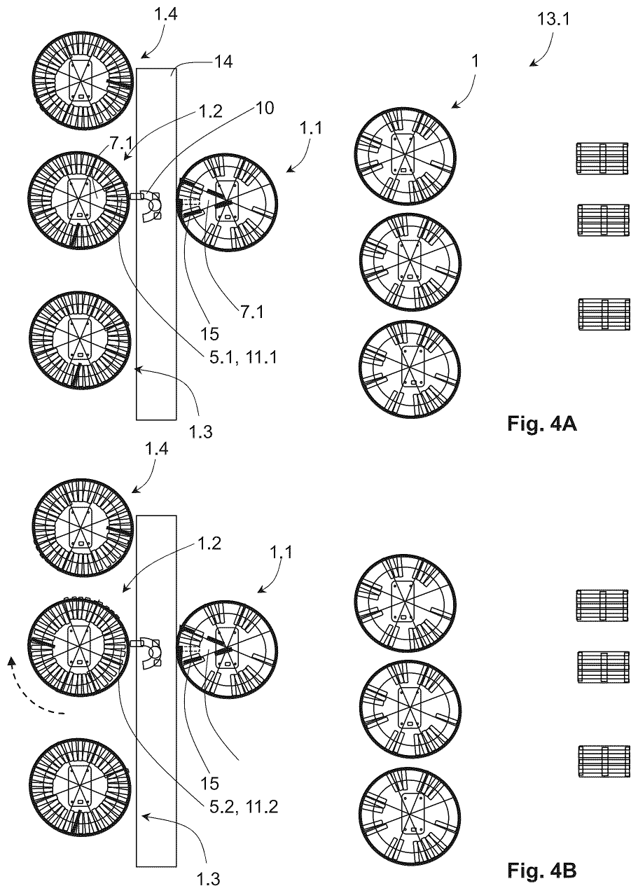

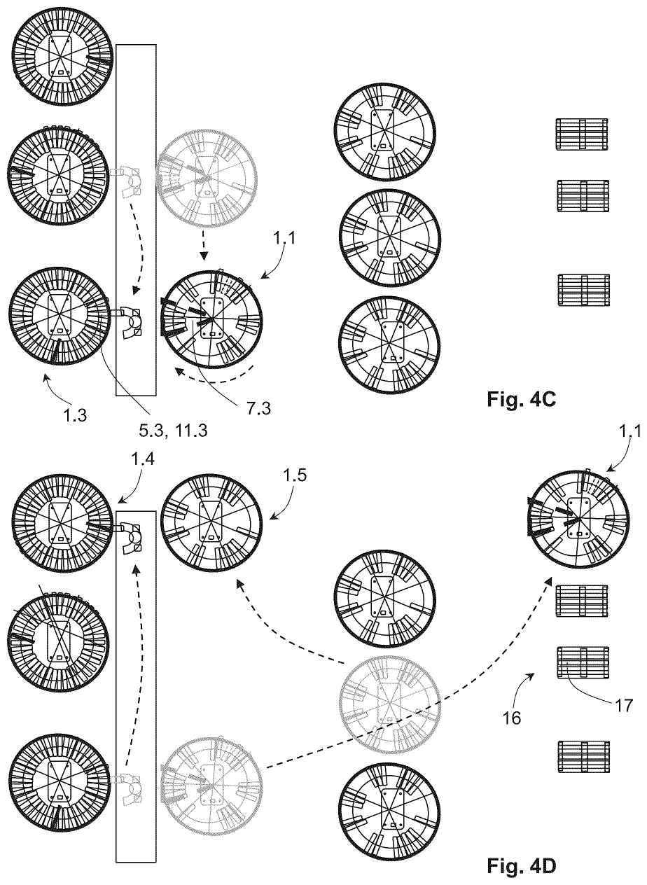

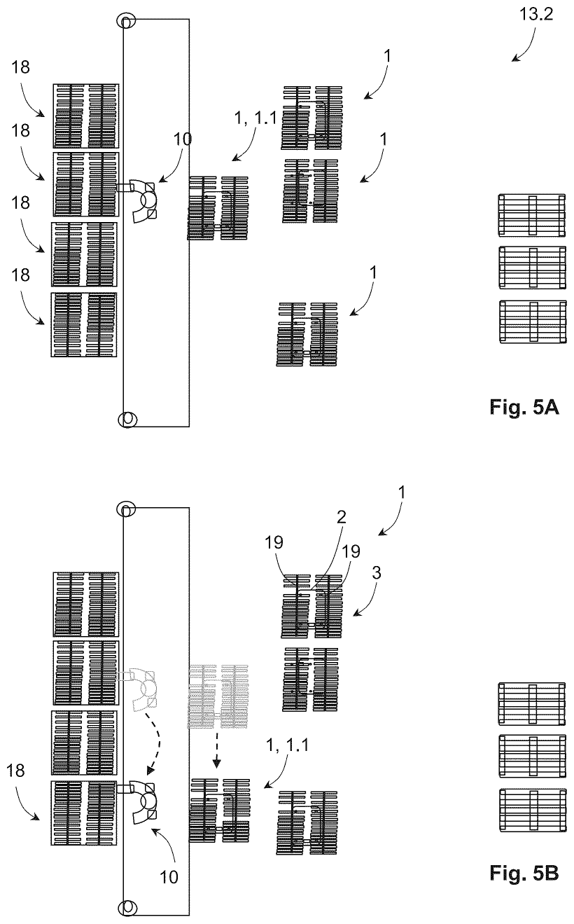

FIGS. 4A to 4D and 5A to 5B each show a schematic top view of several picking systems 1 at different times during the execution of a method 100 for picking goods according to the invention.

To avoid repetition, only selected aspects of the respective embodiment are discussed below.

FIGS. 4A to 4D show a first order picking arrangement 13.1 with a total of seven picking systems 1 according to the invention. Three picking systems 1.2 to 1.4 are used to provide goods 5 to be picked. The order picker 10 moves in a moving area 14 and removes (picks) the goods 5 to be picked from these three picking systems 1.2 to 1.4 in the course of the picking process. The order picker 10 places the previously picked goods 5 to be picked in the four other picking systems 1.

According to FIG. 4A, the second picking system 1.2 has been positioned and rotated such that a first goods sector 7.1 with a first good 5.1 assigned to a first order is facing the order picker 10 and the first good 5.1 is thus provided in (at) the first transfer position 11.1.

The order picker 10 removes the first good 5.1, turns around and places the first good 5.1 in the first goods sector 7.1 of the first order picking system 1.1.

This first goods sector 7.1 of the first picking system 1.1 is assigned to the first order. The first goods receiving device 3.1 of the first picking system 1.1 was previously positioned and rotated so that the first goods sector 7.1 faces the order picker 10. The first goods sector is provided with a marking 15 by means of a put-by-light device.

Then, as shown in FIG. 4B, the second good 5.2 is provided at the second transfer position 11.2. For this purpose, the second goods receiving device 3.2 is rotated in such a way that a second goods sector 7.2 of the second goods receiving device 3.2 faces the order picker 10. The order picker 10 then removes the second good 5.2 from the second order picking system 1.2.

The second good 5.2 is assigned to a second order that is identical to the first order. The second good 5.2 is therefore deposited (placed) by the order picker 10 in the same goods sector of the first picking system 1.1 as the first good 5.1.

The order picker 10 then moves from the second picking system 1.2 to the third order picking system 1.3 as shown in FIG. 4C. Here it picks up a third good 5.3, which is assigned to a third order and has been made available at a third transfer position 11.3. For this purpose, the goods receiving device 3 of the third order picking system 1.3 has been rotated so that the goods sector 7, in which the third good 5.3 is located, faces the order picker 10.

The third order differs from the first and second orders.

The first picking system 1.1 follows the order picker 10 and is positioned in its vicinity. Furthermore, the first goods receiving device 3.1 of the first picking system 1.1 is rotated so that a third goods sector 7.3, which is assigned to the third order, faces the order picker 10. The order picker 10 then places the third good 5.3 in the third goods sector 7.3 of the first order picking device 1.1.

When the first goods receiving device 3.1 of the first picking system 1.1 is fully loaded with goods 5 and thus fully order picked, the first picking system 1.1, as shown in FIG. 4D, is moved to a packing area 16 in which the picked goods 5 are further processed for shipping and loaded onto pallets 17.

The order picker 10 moves to the fourth picking system 1.4 to continue picking. A fifth picking system 1.5 is positioned in its vicinity to take over the role of the first picking system 1.1 and pick up the goods 5 to be picked.

FIGS. 5A and 5B each show a second order picking arrangement 13.2 with a total of four picking systems 1 according to the invention.

A significant difference to the first order picking arrangement according to FIGS. 4A to 4D is that the goods 5 to be picked are not provided in picking systems according to the invention, but in goods provision devices 18, which cannot be moved and rotated with the aid of an automated guided vehicle. The first picking system 1.1 according to the invention follows the order picker 10, who moves to the individual goods provision devices 18 during the order picking process and removes the goods to be picked from there.

A further difference is that the goods receiving devices 3 of the picking systems 1 shown in FIGS. 5A and 5B, which can be rotated relative to the automated guided vehicle, each have two straight clothes rails 19 running parallel to each other—and not a circumferential, circular clothes rail.

### REFERENCE SIGNS

Picking system 1, 1.1, 1.2
Automated guided vehicle 2, 2.1, 2.
Goods receiving device 3, 3.1, 3.2
Clothes rail 4
Good 5, 5.1, 5.2, 5.3
Partition 6
Good sectors 7, 7.1, 7.2
Turntable 8
Wheels 9
Order picker 10
Transfer position 11, 11.1, 11.2
Platform 12
Picking arrangement 13.1, 13.2
Moving area 14
Marking 15
Packing area 16
Pallet 17
Goods provision device 18
Straight clothes rail 19

What is claimed is:

1. A method (100) for picking goods (5, 5.1, 5.2, 5.3) assigned to different orders using a first picking system (1.1) comprising a first automated guided vehicle (2.1) and a first goods receiving device (3.1) rotatably mounted on the first automated guided vehicle (2.1) for receiving goods (5, 5.1, 5.2, 5.3) in order-specific goods sectors (7, 7.1, 7.2) assigned to the different orders, wherein
a first good (5.1) is assigned to a first order and
a second good (5.2) is assigned to a second order,
with the following steps:
A 1) providing (110) the first good (5.1) to be picked, assigned to the first order, at a first transfer position (11.1),
B 1) picking up (120) the first good (5.1) to be picked at the first transfer position (11.1) by an order picker (10),
C 1) positioning (130) the first automated guided vehicle (2.1) together with the first picking system (1.1) in the vicinity of the order picker (10),
D 1) rotating (140) the first goods receiving device (3.1) relative to the first automated guided vehicle (2.1) in such a way that a first goods sector (7.1) of the first goods receiving device (3.1) assigned to the first order faces the order picker (10),
E 1) placing (150) the first good (5.1) to be picked in the first goods sector (7.1) of the first goods receiving device (3.1) by the order picker (10),
A 2) providing (160) the second good (5.2) to be picked, assigned to the second order, at a second transfer position (11.2),
B 2) picking up (170) the second good (5.2) to be picked at the second transfer position (11.2) by the order picker (10),
C 2) positioning (180) the first automated guided vehicle (2.1) together with the first order picking system (1.1) in the vicinity of the order picker (10),
D 2) rotating (190) the first goods receiving device (3.1) relative to the first automated guided vehicle (2.1) in such a way that a second goods sector (7.2) of the first goods receiving device (3.1) assigned to the second order faces the order picker (10), and
E 2) placing (200) the second good (5.2) to be picked in the second goods sector (7.2) of the first goods receiving device (3.1) by the order picker (10).

2. The method (100) for picking goods (5, 5.1, 5.2, 5.3) assigned to different orders of claim 1, wherein the goods (5, 5.1, 5.2, 5.3) to be picked are provided at a transfer position (11.1, 11.2) according to step A 1 and optionally step A 2 using a second picking system (1.2), wherein the second picking system (1.2) comprises a second automated guided vehicle (2.2) and a second goods receiving device (3.2) rotatably mounted on the second automated guided vehicle (2.2) for providing goods (5, 5.1, 5.2, 5.3) in a plurality of goods sectors (7, 7.1, 7.2), with the following steps:
A 11) providing (111) the first good (5.1) to be picked in a first goods sector (7.1) of the second goods receiving device (1.2) and defining this first goods sector (7.1) as the first transfer position (11.1),
A 12) positioning (112) the second automated guided vehicle (1.2) in the vicinity of the order picker (10),
A 13) rotating (113) the second goods receiving device (3.2) relative to the second automated guided vehicle (2.2) in such a way that the first goods sector (7.1) of the second goods receiving device (1.2) faces the order picker (10),
and optionally afterwards
A 21) providing (161) the second good (5.2) to be picked in a second goods sector (7.2) of the second goods receiving device (3.2) and defining this second goods sector (7.2) as the second transfer position (11.2),
A 22) positioning (162) the second automated guided vehicle (1.2) in the vicinity of the order picker (10),
A 23) rotating (163) the second goods receiving device (3.2) relative to the second automated guided vehicle (1.2) in such a way that the second goods sector (7.2) of the second goods receiving device (3.2) faces the order picker (10).

3. The method (100) for picking goods assigned to different orders of claim 1, wherein
according to step C 1 and/or C 2, the first automated guided vehicle (2.1) is positioned in the vicinity of the order picker by the first automated guided vehicle (2.1) following the order picker (10) at a predeterminable first distance or by the first automated guided vehicle (2.1) being positioned in a first order picking area, and/or
according to step A 12 and/or A 22, the second automated guided vehicle (2.2) is positioned in the vicinity of the order picker (10) by the second automated guided vehicle (2.2) following the order picker (10) at a predeterminable second distance or by the second automated guided vehicle (2.2) being positioned in a second order picking area.

4. A picking system (1, 1.1, 1.2) comprising an automated guided vehicle (2, 2.1, 2.2) and a goods receiving device (3, 3.1, 3.2) rotatably supported on the automated guided vehicle for receiving and/or providing goods (5, 5.1, 5.2, 5.3) in a plurality of goods sectors (7, 7.1, 7.2), arranged for use in the method (100) according to claim 1.

5. The picking system (1) of claim 4, wherein the automated guided vehicle (2, 2.1, 2.2) comprises a turntable (8) which is rotatable relative to the automated guided vehicle and on which the goods receiving device (3, 3.1, 3.2) is arranged.

6. The picking system (1) of claim 4, wherein the goods receiving device (3) comprises a circumferential hanging device, which is designed in particular as a clothes rail (4) and enables clothes hangers to be hung up.

7. The picking system (1) of claim 4, wherein the circumferential hanging device is circular, elliptical or polygonal.

8. The picking system (1) of claim 4, wherein the goods receiving device (3) comprises a storage rack accessible from several sides.

9. The picking system (1) of claim 4, wherein the goods sectors (7) of the goods receiving device (3) can each be marked by a light signal by means of a put-by-light device and/or a pick-by-light device.

10. The picking system (1) of claim 4, wherein the goods sectors (7) of the goods receiving device (3) are separated from each other by goods separators, in particular by partitions (6).

11. The picking system (1) of claim 4, wherein the automated guided vehicle (2) is designed as an autonomous automated guided vehicle.

12. A computer program stored on a non-transitory medium comprising instructions that cause an automated guided vehicle (2) of a picking system (1) comprising an automated guided vehicle (2, 2.1, 2.2) and a goods receiving device (3, 3.1, 3.2) rotatably supported on the automated guided vehicle for receiving and/or providing goods (5, 5.1, 5.2, 5.3) in a plurality of goods sectors (7, 7.1, 7.2) to execute:
the process steps C 1 and D 1 and C 2 and D 2 according to claim 1.

13. A computer program stored on a non-transitory medium comprising instructions that cause an automated guided vehicle (2) of a picking system (1) comprising an automated guided vehicle (2, 2.1, 2.2) and a goods receiving device (3, 3.1, 3.2) rotatably supported on the automated guided vehicle for receiving and/or providing goods (5, 5.1, 5.2, 5.3) in a plurality of goods sectors (7, 7.1, 7.2) to execute:
the process steps A 12 and A 13 and optionally the process steps A 22 and A 23 according to claim 2.
